(19) United States
(12) Patent Application Publication
(10) Pub. No.: US 2010/0260578 A1
(43) Pub. Date: Oct. 14, 2010

(54) CAPTIVE SECURING ARRANGEMENT

(75) Inventor: Thomas Ullein, Frensdorf (DE)

Correspondence Address: VOLPE AND KOENIG, P.C., UNITED PLAZA, 30 SOUTH 17TH STREET, PHILADELPHIA, PA, 19103, US

(73) Assignee: SCHAEFFLER TECHNOLOGIES GMBH & CO. KG, Herzogenaurach (DE)

(21) Appl. No.: 12/757,086

(22) Filed: Apr. 9, 2010

(30) Foreign Application Priority Data
Apr. 9, 2009 (DE) 20 2009 005 484.5

(51) Int. Cl. F16B 29/00

(52) U.S. Cl. 411/360

(57) ABSTRACT

A captive securing arrangement for securing a connection element in an opening with a securing element that protects the connection element from falling out. The securing element is constructed integrally from one of the components to be connected and projects in the radial direction into the opening, reducing the opening. The connection element is constructed as a screw that has a shaft diameter D1, a threading diameter D2, and the opening has an opening diameter D3, and a reduced opening diameter D4 that is reduced in the radial direction by the securing element, where D1<D4<D2<D3. The securing element is constructed integrally with the component has a material thickness h that is larger or equal to a thread pitch of the connection element.

### CROSS-REFERENCE TO RELATED APPLICATIONS

This application claims the benefit of German Patent Application No. 20 2009 005 484.5, filed Apr. 9, 2009, which is incorporated herein by reference as if fully set forth.

### FIELD OF THE INVENTION

The present invention relates to a captive securing device for securing a connection element in an opening.

### BACKGROUND OF THE INVENTION

A general trend is to use ever more preassembled parts for series assembly. So that the preassembled components maintain their preassembled state during transport and also during their final assembly, it is useful to install captive securing devices. A captive securing device according to the class named above is known from the publication DE 203 10 784 U1. In this publication, an attachment element is described with a formed threading that should be preassembled within a component. Here, the component has a borehole section that has internal threading. This internal threading is used for engaging the threaded section of the attachment element. Although this is not discussed in more detail in this publication, it is assumed that the internal threading was cut in advance as an additional processing step within the component.

### SUMMARY

The invention is therefore based on the objective of providing a captive securing arrangement that prevents additional and thus cost-intensive processing steps.

This objective is met according to the invention by a captive securing arrangement for securing a connection element in an opening with a securing element that protects the connection element from falling out of the opening, wherein the securing element is constructed integrally from one of the components to be connected and projects in the radial direction into the opening, so that the opening is reduced and the connection element is constructed as a screw that has a shaft diameter D1, a threading diameter D2, and the opening has an opening diameter D3, and a reduced opening diameter D4 that is reduced in the radial direction by the securing element, where D1<D4<D2<D3, and a securing element constructed integrally with the component has a material thickness h that is larger or equal to a thread pitch of the connection element constructed as a screw. For cost-effective production, the component is fabricated in a manufacturing process without additional processing steps, such as, e.g., the cutting of an internal threading in an opening of the component.

In one embodiment of the invention it is provided that the material from which both the component and also the securing element are produced is softer than the material of the connection element. Here, the connection element could involve a steel screw and the component can involve an aluminum or plastic housing. Due to the softer material of the securing element, while turning in the component, the steel screw automatically cuts a thread into the component. The threading diameter D2 must be larger than the reduced opening diameter D4 produced by the securing element. On one hand, so that sufficient material is provided, in order to be able to cut an internal threading in the securing element by the connection element. On the other hand, in this way the falling out of the connection element or the screw from the component after the screwing-in process is prevented.

Another embodiment provides that both of the components, the securing device and the connection element, are produced from materials of identical hardness, such as, e.g., steel or aluminum. Due to this identical material configuration, undesired metal cuttings can be generated during automatic thread cutting, e.g., with a steel screw in a steel component. In order to prevent this, a securing element is arranged as a radial projection within the opening. This projection is provided as a screwing-in aid, assuming the core diameter of the screw threading is here equal to the internal diameter D4 reduced in the radial direction. In addition, the projection is used for securing the screw within the component. After being screwed in, in order to prevent the connection element or the screw from falling out, the reduced opening diameter D4 must be smaller than the threading diameter D2 of the screw.

In a preferred construction of the invention, the securing element or the component connected integrally to this element is produced by pressure die casting. Pressure die casting is an industrial casting method for the mass production of parts. The tolerances that can be achieved lie at ±0.05 to ±0.15 mm. The projection constructed as a securing element lies at a mold separating plane and therefore can be easily generated using casting technology. The mold separating plane is the plane in which the mold parts of the closed mold abut each other.

It can also be provided that the component is constructed as a clamp housing that can be installed by a connection element for fixing on a combustion engine.

### BRIEF DESCRIPTION OF THE DRAWINGS

Embodiments of the invention are shown in the figures that are described in detail below, wherein the invention is not limited to these embodiments.

In the drawings:

FIG. 1 is a view of a connection element captively secured within a component, and

FIG. 2 is a view of another embodiment of an arrangement for holding a connection element in a captively secured manner within a component.

### DETAILED DESCRIPTION OF THE PREFERRED EMBODIMENTS

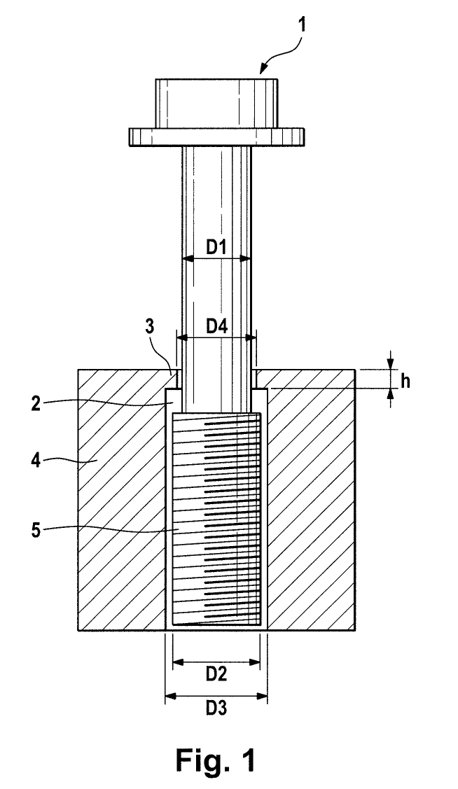

FIG. 1 shows a component 4 that is provided with a through opening 2. A radial reduction of the opening 2 is formed on one of the ends of the opening 2. This radial reduction is produced via the securing element 3 that is connected integrally to the component 4 and projects into the opening 2 in the radial direction. The opening diameter D3 is consequently larger than the reduced opening diameter D4. Within the component 4, a connection element 1 is provided that should be held in a captively secured manner. The connection element has a shaft diameter D1 and a thread 5 abutting the shaft with a thread diameter D2. Here, the thread diameter D2 is larger than the reduced opening diameter D4. The shaft diameter D1 is smaller, in turn, than the reduced opening diameter D4. The securing element 3 has a height h that corresponds to at least a thread pitch of the thread 5 formed on the connection element. During screwing in, the connection element 1 automatically cuts an internal thread into the securing element 3 by its thread 5. The connection element 1 screwed into the component 4 up to its shaft is secured against falling out, because the thread diameter D2 is larger than the reduced opening diameter D4.

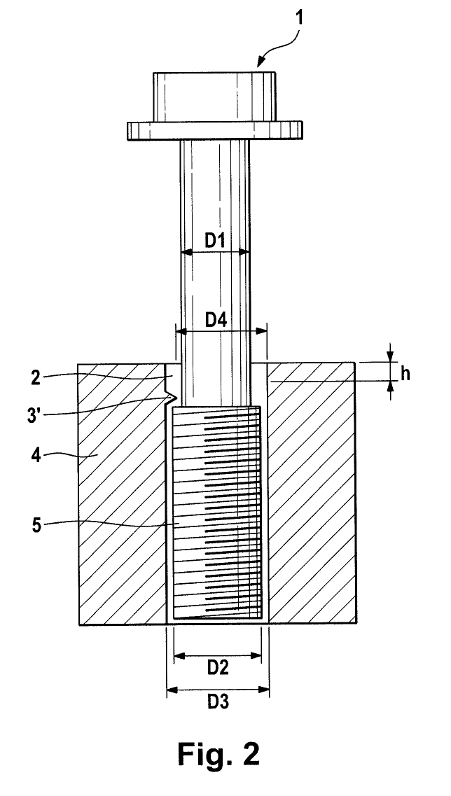

FIG. 2 likewise shows a component 4 with a through opening 2 and a connection element 1 constructed as a screw. The component 4 also has a securing element 3′ constructed integrally with it. The securing element 3′ projects in the radial direction as a projection into the opening 2 of the component. It is used to secure the connection element 1 from falling out within the opening 2 of the component 4. While screwing the connection element into the component, the securing element 3′ acts as a screwing-in aid. The reduced opening diameter D4 constructed on the base of the securing element 3′ corresponds to the core diameter of the thread 5 of the connection element 1. Just as in FIG. 1, the thread diameter D2 is larger than the reduced opening diameter D4. This has the result that the connection element 1, when it is screwed into the component 4 up to its shaft, is secured against falling out from the component 4.

### REFERENCE NUMBERS

Connection element
1 Opening
3, 3′ Securing element
4 Component
5 Thread
D1 Shaft diameter
D2 Thread diameter
D3 Opening diameter
D4 Opening diameter (reduced)
h Material thickness

1. A captive securing arrangement for securing a connection element in an opening, comprising a securing element securing the connection element in the opening against falling out, the securing element is constructed integrally from one of the components to be connected and projects in a radial direction into the opening, so that the opening is reduced in the radial direction and the connection element is constructed as a screw that has a shaft diameter D1 and a thread diameter D2, and the opening has an opening diameter D3, and a reduced opening diameter D4 that is reduced in the radial direction by the securing element, where D1<D4<D2<D3, and the securing element has a material thickness h that is greater than or equal to a thread pitch of the connection element.

2. The captive securing arrangement according to claim 1, wherein the connection element is produced from a harder material than the securing element.

3. The captive securing device according to claim 2, wherein the component to be connected is produced with a securing element made from the same material as the connection element.

4. The captive securing device according to claim 1, wherein the securing element is produced by pressure die casting.

5. The captive securing device according to claim 4, wherein the component is constructed as a clamp housing that is constructed by a connection element for fixing on a combustion engine.
